(19) United States
(12) Patent Application Publication
(10) Pub. No.: US 2020/0062173 A1
(43) Pub. Date: Feb. 27, 2020

(54) NOTIFICATION CONTROL APPARATUS AND METHOD FOR CONTROLLING NOTIFICATION

(71) Applicant: Mitsubishi Electric Corporation, Tokyo (JP)

(72) Inventors: Tadashi MIYAHARA, Tokyo (JP); Mitsuo SHIMOTANI, Tokyo (JP); Naohiko OBATA, Tokyo (JP); Yoshinori UENO, Tokyo (JP); Yuji MATSUDA, Tokyo (JP)

(73) Assignee: Mitsubishi Electric Corporation, Tokyo (JP)

(21) Appl. No.: 16/487,653

(22) PCT Filed: Apr. 24, 2017
(86) PCT No.: PCT/JP2017/016147

§ 371 Date: Aug. 21, 2019

(51) Int. Cl. B60Q 1/50; G08G 1/16; G06F 3/0488; G06F 3/0484; G06K 9/00; G09G 3/00

(52) U.S. Cl. CPC B60Q 1/503; G08G 1/161; G06F 3/04883; G06K 2209/21; G06K 9/00248; G09G 3/001; B60Q 2400/50; G06F 3/04845

(57) ABSTRACT

An object of the present invention to provide a notification control apparatus and a method for controlling notification that achieve display to a notification target with improved accuracy. A notification control apparatus in the present invention includes the following: a notification message acquiring unit that acquires a notification message for a notification target located around a subject vehicle; a gesture operation recognizing unit that recognizes a gesture of the driver of the subject vehicle; a road projection location determining unit that determines, on the basis of the gesture recognized by the gesture operation recognizing unit, a location for projecting the notification message acquired by the notification message acquiring unit onto a road; and a road projection controller that controls projection of the notification message onto the location determined by the road projection location determining unit.

### TECHNICAL FIELD

The present invention relates to a notification control apparatus that controls notification of a driver's intention to a notification target located around a subject vehicle. The present invention also relates to a method for controlling such notification.

### BACKGROUND ART

A conventionally disclosed technique is to project an image warning a pedestrian that a vehicle is approaching onto a road on which the pedestrian is located (c.f., Patent Document 1).

### PRIOR ART DOCUMENT

### Patent Document

Patent Document 1: Japanese Patent Application Laid-Open No. 2008-7079

### SUMMARY

### Problem to be Solved by the Invention

In Patent Document 1, a predetermined message is projected onto a predetermined location. A driver's intention is thus not always projected onto an intended location. That is, the accuracy of display to a notification target is poor in the conventional technique.

To solve this problem, it is an object of the present invention to provide a notification control apparatus and a method for controlling notification that achieve display to a notification target with improved accuracy.

### Means to Solve the Problem

A notification control apparatus in the present invention includes the following: a notification message acquiring unit that acquires a notification message for a notification target located around a subject vehicle; a gesture operation recognizing unit that recognizes a gesture of the driver of the subject vehicle; a road projection location determining unit that determines, on the basis of the gesture recognized by the gesture operation recognizing unit, a location for projecting the notification message acquired by the notification message acquiring unit onto a road; and a road projection controller that controls projection of the notification message onto the location determined by the road projection location determining unit.

A method for controlling notification in the present invention includes the following: acquiring a notification message for a notification target located around a subject vehicle; recognizing a gesture of the driver of the subject vehicle; determining, on the basis of the recognized gesture, a location for projecting the acquired notification message onto a road; and controlling projection of the notification message onto the determined location.

### Effects of the Invention

The notification control apparatus includes the following: the notification message acquiring unit that acquires the notification message for the notification target located around the subject vehicle; the gesture operation recognizing unit that recognizes the gesture of the driver of the subject vehicle; the road projection location determining unit that determines, on the basis of the gesture recognized by the gesture operation recognizing unit, the location for projecting the notification message acquired by the notification message acquiring unit onto the road; and the road projection controller that controls the projection of the notification message onto the location determined by the road projection location determining unit. The notification control apparatus thus improves the accuracy of display to the notification target.

The method for controlling notification includes the following: acquiring the notification message to the notification target located around the subject vehicle; recognizing the gesture of the driver of the subject vehicle; determining, on the basis of the recognized gesture, the location for projecting the acquired notification message onto the road; and controlling the projection of the notification message onto the determined location. The method thus improves the accuracy of display to the notification target.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram illustrating one example of the configuration of a notification control apparatus according to a first embodiment of the present invention.

FIG. 2 is a block diagram illustrating one example of the configuration of the notification control apparatus according to the first embodiment of the present invention.

FIG. 3 is a block diagram illustrating one example of the hardware configuration of the notification control apparatus according to the first embodiment of the present invention.

FIG. 4 is a flowchart showing one example of a process performed in the notification control apparatus according to the first embodiment of the present invention.

FIG. 5 is a diagram for describing one example of the operation of the notification control apparatus according to the first embodiment of the present invention.

FIG. 6 is a diagram for describing one example of the operation of a notification control apparatus according to a second embodiment of the present invention.

FIG. 7 is a block diagram illustrating one example of the configuration of the notification control apparatus according to the second embodiment of the present invention.

FIG. 8 is a flowchart showing one example of a process performed in the notification control apparatus according to the second embodiment of the present invention.

FIG. 9 is a flowchart showing one example of a process performed in a notification control apparatus according to a third embodiment of the present invention.

FIG. 10 is a diagram for describing one example of the operation of the notification control apparatus according to the third embodiment of the present invention.

FIG. 11 is a diagram for describing one example of the operation of the notification control apparatus according to the third embodiment of the present invention.

FIG. 12 is a diagram for describing one example of the operation of the notification control apparatus according to a fourth embodiment of the present invention.

FIG. 13 is a block diagram illustrating one example of the configuration of a notification control apparatus according to the fourth embodiment of the present invention.

FIG. 14 is a flowchart showing one example of a process performed in the notification control apparatus according to the fourth embodiment of the present invention.

FIG. 15 is a block diagram illustrating one example of the configuration of a notification control apparatus according to a fifth embodiment of the present invention.

FIG. 16 is a block diagram illustrating one example of the configuration of a notification control apparatus according to a sixth embodiment of the present invention.

FIG. 17 is a flowchart showing one example of a process performed in the notification control apparatus according to the sixth embodiment of the present invention.

FIG. 18 is a diagram for describing one example of the operation of the notification control apparatus according to the sixth embodiment of the present invention.

FIG. 19 is a diagram illustrating one example of a notification message and one example of an additional message in the sixth embodiment of the present invention.

FIG. 20 is a block diagram illustrating one example of the configuration of a notification control system according to the embodiments of the present invention.

### DESCRIPTION OF EMBODIMENT(S)

The embodiments of the present invention will be described with reference to the drawings.

### First Embodiment

<Configuration>

The following describes one example of the configuration of a notification control apparatus according to a first embodiment of the present invention.

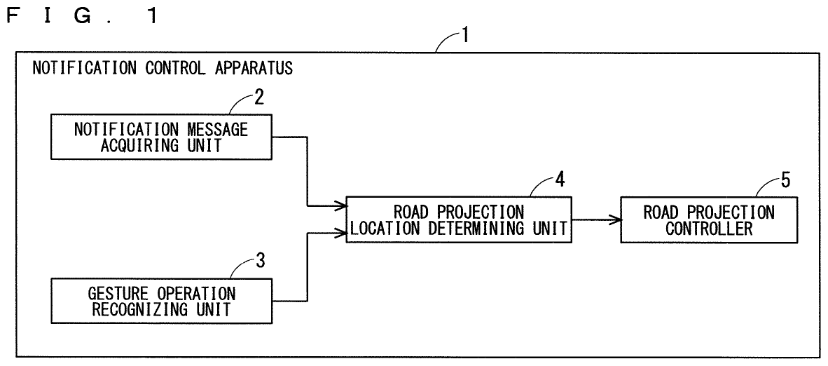

FIG. 1 is a block diagram illustrating one example of the configuration of a notification control apparatus 1 according to the first embodiment. FIG. 1 shows minimal components necessary for constituting the notification control apparatus according to the embodiment.

As illustrated in FIG. 1, the notification control apparatus 1 includes a notification message acquiring unit 2, a gesture operation recognizing unit 3, a road projection location determining unit 4, and a road projection controller 5. The notification message acquiring unit 2 acquires a notification message for a notification target located around a subject vehicle. The gesture operation recognizing unit 3 recognizes a gesture of the driver of the subject vehicle. The road projection location determining unit 4 determines, on the basis of the gesture recognized by the gesture operation recognizing unit 3, a location for projecting the notification message acquired by the notification message acquiring unit 2 onto a road. The road projection controller 5 controls projection of the notification message onto the location determined by the road projection location determining unit 4.

The following describes the configuration of another notification control apparatus including the notification control apparatus 1 illustrated in FIG. 1.

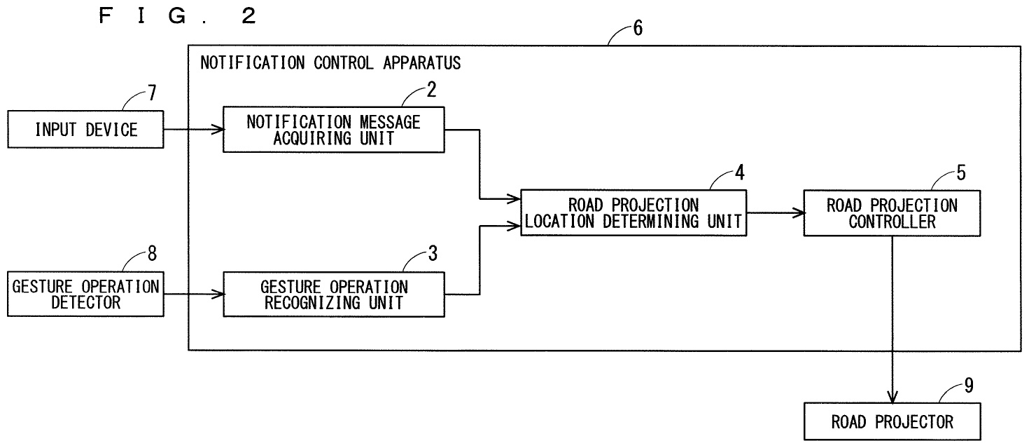

FIG. 2 is a block diagram illustrating one example of the configuration of a notification control apparatus 6.

As illustrated in FIG. 2, the notification control apparatus 6 includes the notification message acquiring unit 2, the gesture operation recognizing unit 3, the road projection location determining unit 4, and the road projection controller 5. The notification message acquiring unit 2 is connected to an input device 7. The gesture operation recognizing unit 3 is connected to a gesture operation detector 8. The road projection controller 5 is connected to a road projector 9.

The notification message acquiring unit 2 acquires a notification message entered by the driver via the input device 7. Examples of driver's input include the driver's selection of a notification message displayed on a screen, and the driver's input of a sound indicating a notification message. Examples of the input device 7 include a touch panel and a microphone.

The gesture operation recognizing unit 3 recognizes the driver's gesture detected by the gesture operation detector 8. To be specific, the gesture operation recognizing unit 3 recognizes the position of driver's fingers, the direction of driver's fingertips, and the path of the movement of the driver's fingers, and other things. The gesture operation detector 8 is a camera for instance.

The road projection location determining unit 4 determines, on the basis of the gesture recognized by the gesture operation recognizing unit 3, a location for projecting the notification message acquired by the notification message acquiring unit 2 onto a road. For a driver's gesture of pointing, the road projection location determining unit 4 determines a location on a road at which the driver is pointing, on the basis of two places pointed by his/her finger including the fingertip recognized by the gesture operation recognizing unit 3. At this time, when a camera (not shown) or other things can detect the position of the driver's eyes, the road projection location determining unit 4 may determine a location on the road at which the driver is pointing, on the basis of the two places pointed by the driver's finger including the fingertip and the position of the driver's eyes. Such a configuration enhances the accuracy of the match between the location on the road at which the driver is pointing through the gesture and a location at which the road projector 9 projects the notification message onto the road. The details will be described later on. It is noted that the position of the driver's eyes may be based on estimation instead of actual measurement using a camera or other means.

The road projection controller 5 controls the road projector 9 to project the notification message onto the location determined by the road projection location determining unit 4. The road projector 9 projects the notification message under the control of the road projection controller 5.

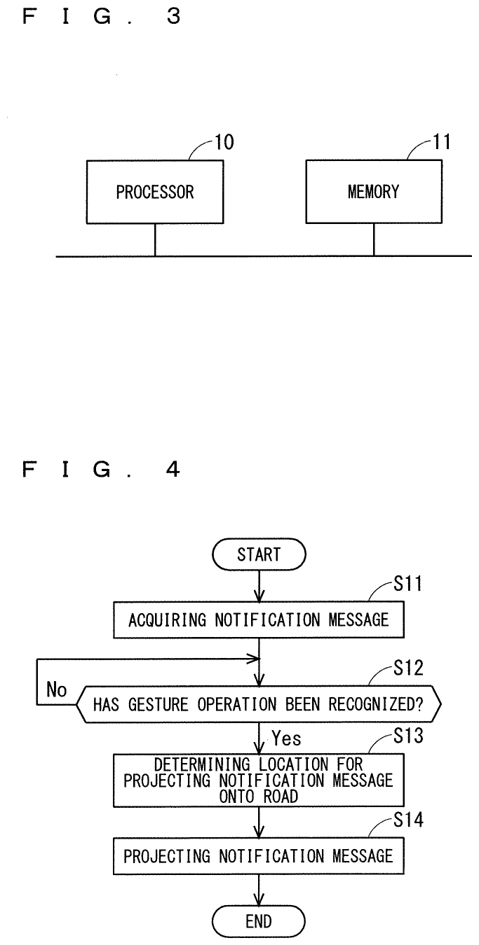

FIG. 3 is a block diagram illustrating one example of the hardware configuration of the notification control apparatus 6. This hardware configuration is applied to the notification control apparatus 1.

A processing circuit implements the functions of the notification message acquiring unit 2, the gesture operation recognizing unit 3, the road projection location determining unit 4, and the road projection controller 5 of the notification control apparatus 6. That is, the notification control apparatus 6 includes a processing circuit for performing the following functions: acquiring a notification message; recognizing a gesture; determining a location for projecting the notification message onto a road; and controlling the road projector 9 to project the notification message. The processing circuit is a processor 10 that executes a program stored in a memory 11. Examples of the processor 10 include a central processing unit, a processing unit, a calculating unit, a microprocessor, a microcomputer, and a digital signal processor (DSP).

Software, firmware, or a combination of software and firmware implements the functions of the notification message acquiring unit 2, the gesture operation recognizing unit 3, the road projection location determining unit 4, and the road projection controller 5 of the notification control apparatus 6. The software or firmware is written as a program, and stored in the memory 11. The processing circuit reads and executes the program, stored in the memory 11, to implement the function of each component. That is, the notification control apparatus 6 includes the memory 11 for storing a program that executes the following process steps: acquiring a notification message; recognizing a gesture; determining a location for projecting the notification message onto a road; and controlling the road projector 9 to project the notification message. This program is for controlling a computer to execute the procedure or method of the notification message acquiring unit 2, the gesture operation recognizing unit 3, the road projection location determining unit 4, and the road projection controller 5. Here, the memory may be a volatile or non-volatile semiconductor memory (e.g., a random access memory or RAM for short, a read only memory or ROM for short, a flash memory, an erasable programmable read only memory or EPROM for short, or an electrically erasable programmable read only memory or EEPROM for short), a magnetic disk, a flexible disk, an optical disk, a compact disk, a mini disk, a DVD, or other things. Alternatively, the memory may be any kind of storing medium that will be used in the future.

<Operation>

The following describes a process performed in the notification control apparatus 6.

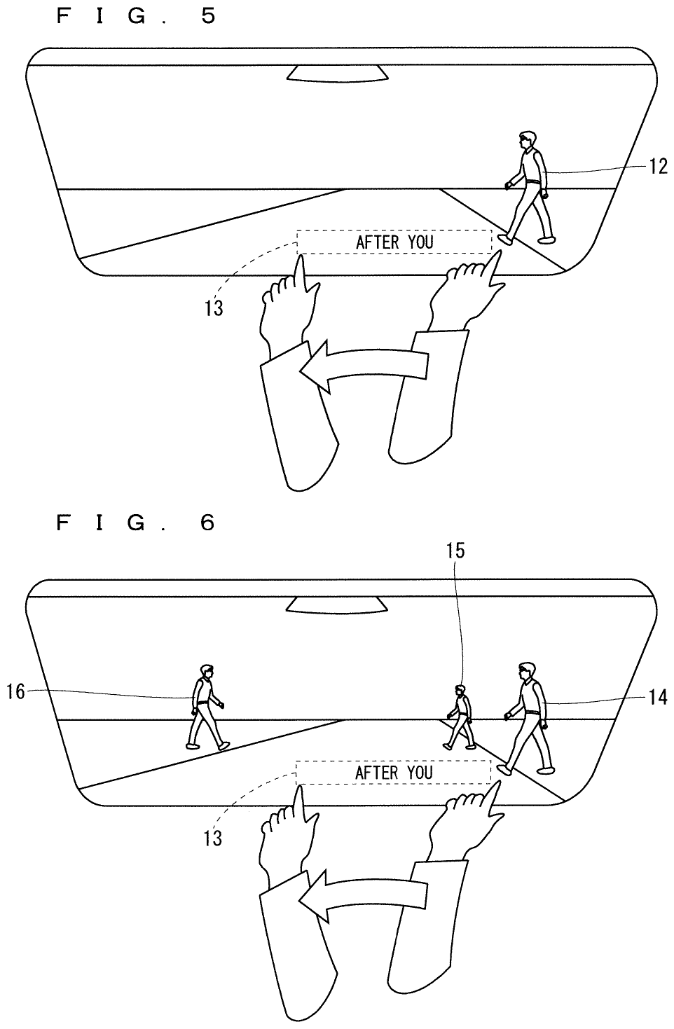

FIG. 4 is a flowchart showing one example of the process performed in the notification control apparatus 6.

In step S11, the notification message acquiring unit 2 acquires a notification message entered by the driver via the input device 7. When the driver says “AFTER YOU” via a microphone, which is the input device 7, the notification message acquiring unit 2 acquires the voice “AFTER YOU” as a notification message. Moreover, when the driver operates a touch panel, which is the input device 7, to select a character string “AFTER YOU”, the notification message acquiring unit 2 acquires the character string “AFTER YOU” as a notification message.

In step S12, the gesture operation recognizing unit 3 determines whether it has recognized a driver's gesture detected by the gesture operation detector 8. The process repeats step S12 until the gesture operation recognizing unit 3 recognizes a gesture. Upon the recognition of a gesture, the process proceeds to step S13. It is noted that the process in FIG. 4 may end when the gesture operation recognizing unit 3 fails to recognize a gesture for a predetermined time.

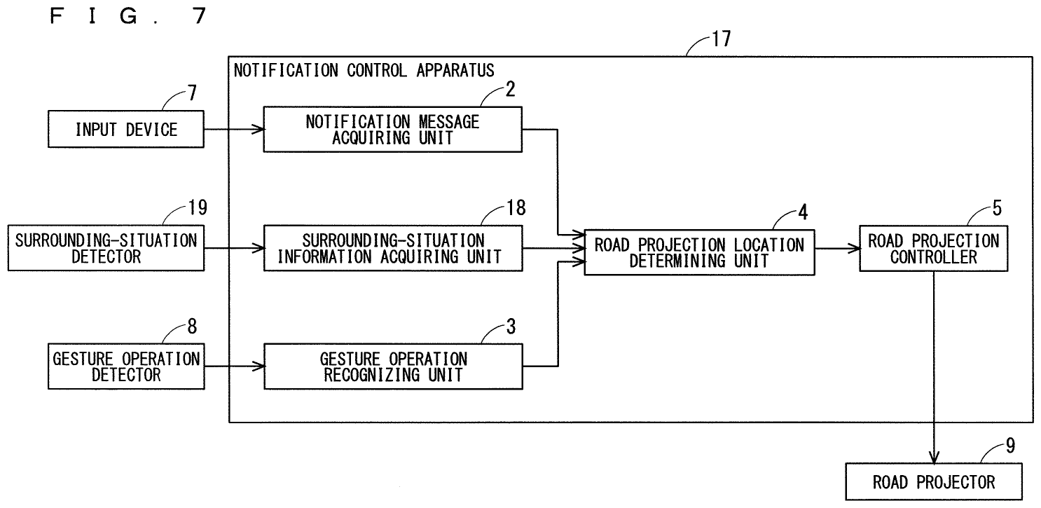

In step S13, the road projection location determining unit 4 determines, on the basis of the gesture recognized by the gesture operation recognizing unit 3, a location for projecting the notification message acquired by the notification message acquiring unit 2 onto a road. FIG. 5 illustrates an instance where the gesture operation recognizing unit 3 recognizes the start and end points of a driver's gesture in front of a notification target 12. The road projection location determining unit 4 accordingly determines the section between the start and end points of the gesture recognized by the gesture operation recognizing unit 3, as a location for projecting the notification message onto the road.

In step S14, the road projection controller 5 controls the road projector 9 to project the notification message onto the location determined by the road projection location determining unit 4. The road projector 9 projects the notification message in front of the notification target under the control of the road projection controller 5. In the example in FIG. 5, the road projector 9 projects a notification message 13 saying “AFTER YOU”, in front of the notification target 12.

It is noted that in step S13, the road projection location determining unit 4 may change the layout of the notification message in accordance with the gesture recognized by the gesture operation recognizing unit 3. In response to a driver's gesture of moving a finger in an arc for instance, the road projection location determining unit 4 may determine a location for projecting the notification message in the form of an arc onto the road.

It is also noted that in step S13, the road projection location determining unit 4 may change the form of the display of the notification message, in accordance with the gesture recognized by the gesture operation recognizing unit 3. In response to a driver's gesture indicating a change of the form of display for instance, the road projection location determining unit 4 may change the form of the display of the notification message. Examples of the form of the display include blinking the notification message, animating the notification message, and emphasizing part of the notification message.

When there are a plurality of microphones, which are the input devices 7, the notification message acquiring unit 2 may acquire the directivity of a driver's sound from each input device 7. In this case, the road projection location determining unit 4 may determine a location for projecting the notification message onto the road, on the basis of the gesture recognized by the gesture operation recognizing unit 3 and the directivity of the driver's sound acquired by the notification message acquiring unit. The road projection location determining unit 4 consequently determines a location for projecting the notification message with improved accuracy.

As described above, the notification control apparatus according to the first embodiment determines, on the basis of the driver's gesture, a location for projecting the notification message onto the road. The notification control apparatus consequently projects a driver's intention onto an intended location. That is, the notification control apparatus improves the accuracy of display to the notification target.

### Second Embodiment

A second embodiment of the present invention describes an instance where there are a plurality of notification targets. A notification control apparatus according to the second embodiment, which is similar to the notification control apparatus 6 in FIG. 2, will not be elaborated upon. The following description equates the notification control apparatus according to the second embodiment with the notification control apparatus 6 illustrated in FIG. 2.

A process performed in the notification control apparatus 6 according to the second embodiment is basically the same as that shown in FIG. 4. Characteristic process steps in the second embodiment will be focused on with reference to FIG. 4.

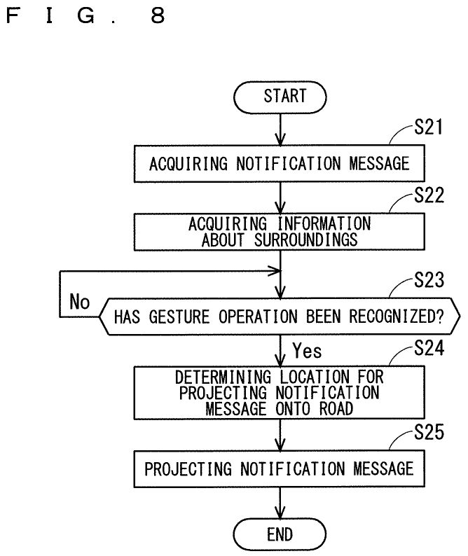

The process proceeds to step S13 if the gesture operation recognizing unit 3 recognizes a gesture for selecting one of a plurality of notification targets in step S12. As illustrated in FIG. 6 for instance, the driver points at the start point of a gesture to select a notification target 14 from among a plurality of notification targets 14 to 16.

In step S13, the road projection location determining unit 4 determines the position of the notification target selected in step S12, as a location for projecting the notification message. In the example in FIG. 6, the driver points at the start point of the gesture to select the notification target 14, followed by pointing at the end point of the gesture in step S12. The road projection location determining unit 4 accordingly determines a location for projecting the notification message 13.

<Modification>

<Configuration>

FIG. 7 is a block diagram illustrating one example of the configuration of a notification control apparatus 17 according to a modification of the second embodiment.

As illustrated in FIG. 7, the notification control apparatus 17 includes a surrounding-situation information acquiring unit 18. The other components, which are similar to those of the notification control apparatus 6 in FIG. 2, will not be elaborated upon.

The surrounding-situation information acquiring unit 18 acquires, from a surrounding-situation detector 19, information about surroundings including the position of a notification target relative to the subject vehicle. The surrounding-situation detector 19 is installed in the subject vehicle, and includes a camera, a millimeter-wave radar, an ultrasonic sensor, and other things.

A processing circuit implements the function of the surrounding-situation information acquiring unit 18 of the notification control apparatus 17. That is, the notification control apparatus 17 includes a processing circuit for acquiring information about surroundings including the position of a notification target relative to the subject vehicle. The processing circuit is the processor 10 that executes a program stored in the memory 11 as illustrated in FIG. 3. The other functions of the notification control apparatus 17 are similar to those of the notification control apparatus 6 illustrated in FIG. 2.

Software, firmware, or a combination of software and firmware implements the function of the surrounding-situation information acquiring unit 18 of the notification control apparatus 17. As illustrated in FIG. 3, the software or firmware is written as a program and stored in the memory 11. The processing circuit reads and executes the program, stored in the memory 11, to implement the function of the surrounding-situation information acquiring unit 18. That is, the notification control apparatus 17 includes the memory 11 for storing a program that executes a process step of acquiring information about surroundings including the position of a notification target relative to the subject vehicle. This program is for controlling a computer to execute the procedure or method of the surrounding-situation information acquiring unit 18. The other functions of the notification control apparatus 17 are similar to those of the notification control apparatus 6 illustrated in FIG. 2.

<Operation>

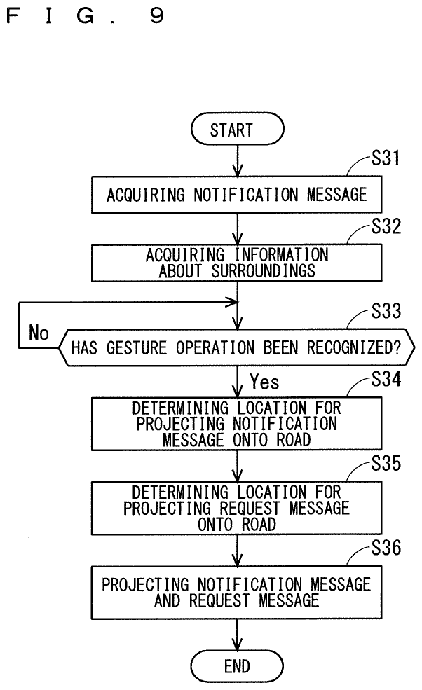

FIG. 8 is a flowchart showing one example of a process performed in the notification control apparatus 17. Steps S21, S23, and S25 in FIG. 8 are similar to the respective process steps of the process performed in the notification control apparatus 6 according to the second embodiment. These process steps thus will not be elaborated upon. Steps S22 and S24 will be described.

In step S22, the surrounding-situation information acquiring unit 18 acquires, from the surrounding-situation detector 19, information about surroundings including the position of a notification target relative to the subject vehicle. In the example in FIG. 6, the surrounding-situation information acquiring unit 18 acquires information about surroundings including the positions of the notification targets 14 to 16 relative to the subject vehicle.

In step S24, the road projection location determining unit 4 determines a location for projecting the notification message, on the basis of the position of the notification target selected in step S23 and the relative position of the notification target acquired in step S22. In the example in FIG. 6, the driver points at the start point of the gesture to select the notification target 14, followed by pointing at the end point of the gesture in step S23. The road projection location determining unit 4 accordingly determines a location for projecting the notification message. At this time, the road projection location determining unit 4, which reflects the relative position of the notification target acquired in step S22, enables projection of the notification message 13 onto a location that is more accurate with respect to the notification target 14.

It is noted that in step S22, the surrounding-situation information acquiring unit 18 may acquire the orientation of the face of the notification target. This allows the road projection location determining unit 4 to determine the orientation of the notification message in accordance with the orientation of the notification target's face so that the notification target can easily read the notification message.

As described above, the notification control apparatus according to the second embodiment selects one of the notification targets, and projects the notification message for the selected notification target located at the location. That is, the notification control apparatus enables projection of a driver's intention to the notification target selected by the driver onto an intended location. The notification control apparatus thus improves the accuracy of display to the notification target. For instance, the driver can select one of notification targets by pointing at the notification target at a place, such as an intersection with no traffic lights at which there are a plurality of pedestrians, vehicles, and others, i.e., the notification targets.

### Third Embodiment

A third embodiment of the present invention describes projection of a notification message for one notification target selected by the driver of the subject vehicle from among a plurality of notification targets, and describes projection of a predetermined message different from this notification message, for the other notification targets. A notification control apparatus according to the third embodiment, which is similar to the notification control apparatus 17 in FIG. 7, will not be elaborated upon. The following description equates the notification control apparatus according to the third embodiment with the notification control apparatus 17 illustrated in FIG. 7.

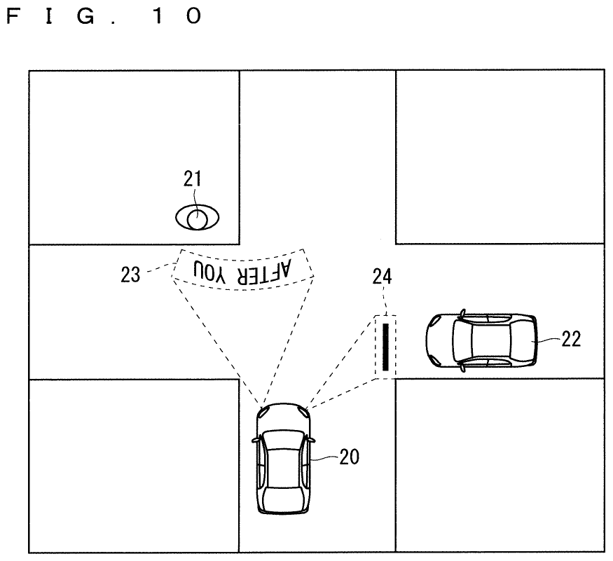

FIG. 9 is a flowchart showing one example of a process performed in the notification control apparatus 17 according to the third embodiment.

In step S31, the notification message acquiring unit 2 acquires a notification message entered by the driver via the input device 7.

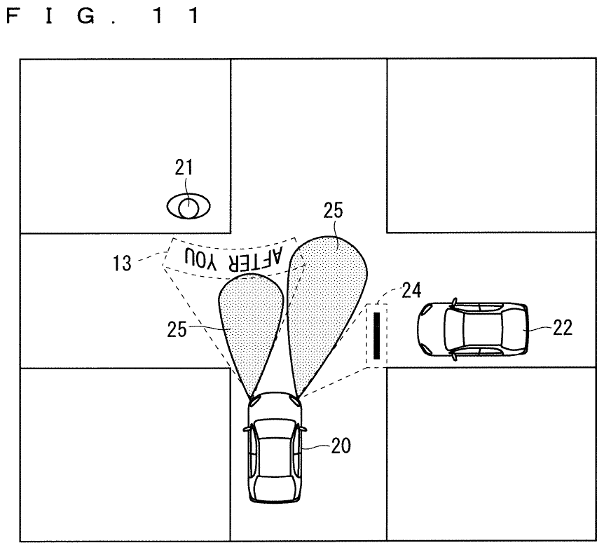

In step S32, the surrounding-situation information acquiring unit 18 acquires, from the surrounding-situation detector 19, information about surroundings including the position of a notification target relative to the subject vehicle. As illustrated in FIG. 10 for instance, the surrounding-situation information acquiring unit 18 acquires information about surroundings including the positions of a notification target 21 and a non-subject vehicle 22 relative to a subject vehicle 20. In the example in FIG. 10, the driver of the non-subject vehicle 22 is a notification target.

The process repeats step S33 until the gesture operation recognizing unit 3 recognizes a gesture for selecting one of the notification targets. The process proceeds to step S34 when the gesture operation recognizing unit 3 recognizes a gesture for selecting one of the notification targets. In the example in FIG. 10, the driver points at the start point of the gesture to select a notification target 21 between the notification target 21 and the non-subject vehicle 22.

In step S34, the road projection location determining unit 4 determines a location for projecting the notification message, on the basis of the position of the notification target selected in step S33 and the relative position of the notification target acquired in step S32. In the example in FIG. 10, the driver points at the start point of the gesture to select the notification target 21, followed by pointing at the end point of the gesture in step S33. The road projection location determining unit 4 accordingly determines a location for projecting the notification message.

In step S35, the road projection location determining unit 4 determines the relative position of the non-subject vehicle 22 acquired in step S32, as a location for projecting a predetermined request message. The request message herein is a message for the notification targets other than the one selected by the driver.

In step S36, the road projection controller 5 controls the road projector 9 to project the notification message onto the location determined by the road projection location determining unit 4. The road projector 9 projects the notification message in front of the notification target selected by the driver under the control of the road projection controller 5. In the example in FIG. 10, the road projector 9 projects a notification message 23 saying “AFTER YOU”, in front of the notification target 21.

The road projection controller 5 also controls the road projector 9 to project the request message onto the location determined by the road projection location determining unit 4. The road projector 9 projects the request message in front of the notification targets under the control of the road projection controller 5. In the example in FIG. 10, the road projector 9 projects a request message 24 saying “STOP”, in front of the non-subject vehicle 22.

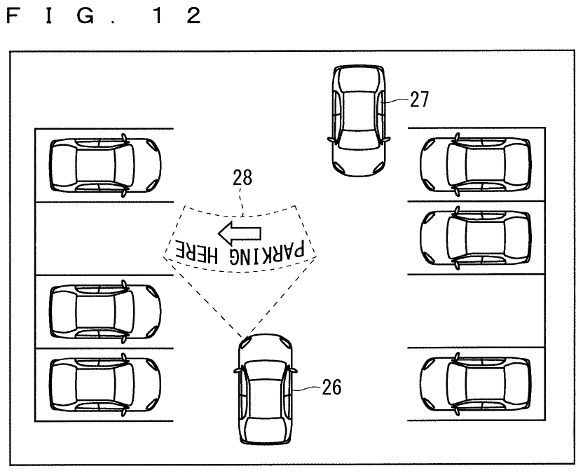

It is noted that as illustrated in FIG. 11, the driver of the subject vehicle 20 may control the subject vehicle 20 so that the notification target 21, a target for projecting the notification message, is not directly irradiated with a headlight beam 25.

As described above, the notification control apparatus according to the third embodiment projects the notification message for one notification target selected by the driver from among the notification targets, and projects the request message to the other notification targets. The notification control apparatus enables projection of a driver's intention for the notification target selected by the driver onto an intended location, and enables suitable notification to the other notification targets. For a pedestrian who is about to cross a road at an intersection, for instance, the notification control apparatus allows the driver of the subject vehicle to make a notification asking the pedestrian to cross the road, and to make a notification asking the driver of a non-subject vehicle that is about to enter the intersection from a different direction, to await the pedestrian's crossing.

### Fourth Embodiment

A fourth embodiment of the present invention describes an instance where a notification message is projected in a particular place, such as a parking lot. A notification control apparatus according to the fourth embodiment, which is similar to the notification control apparatus 6 in FIG. 2, will not be elaborated upon. The following description equates the notification control apparatus according to the fourth embodiment with the notification control apparatus 6 illustrated in FIG. 2.

A process performed in the notification control apparatus 6 according to the fourth embodiment is basically the same as that shown in FIG. 4. Characteristic process steps in the fourth embodiment will be focused on with reference to FIG. 4.

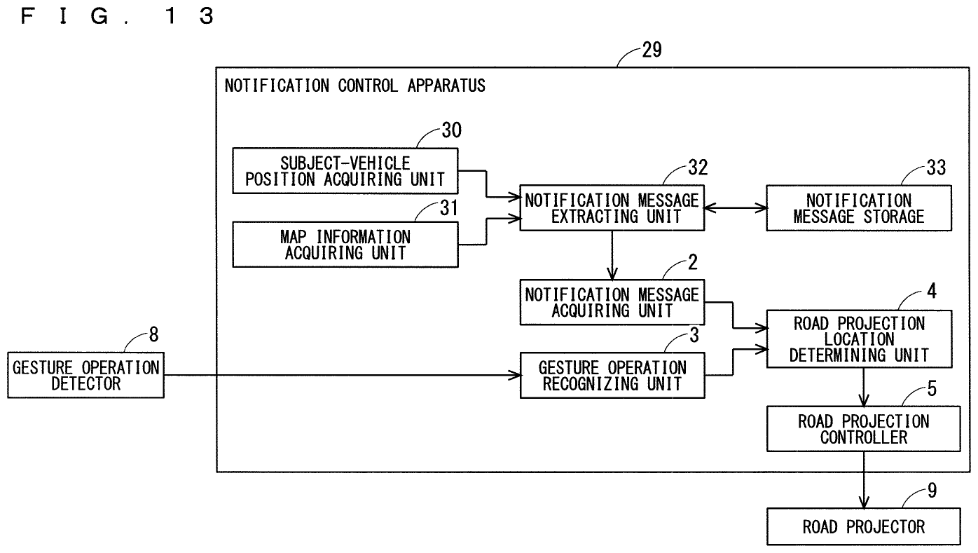

The process proceeds to step S13 if the gesture operation recognizing unit 3 recognizes a gesture for selecting a notification target in step S12. As illustrated in FIG. 12 for instance, the driver points at the start point of a gesture to select the driver of a non-subject vehicle 27 as a notification target. FIG. 12 illustrates that a subject vehicle 26 and the non-subject vehicle 27 is in a parking lot, and that the driver of the subject vehicle 26 is about to park the subject vehicle 26 in an empty space.

In step S14, the road projection controller 5 controls the road projector 9 to project the notification message onto the location determined by the road projection location determining unit 4. The road projector 9 projects the notification message in front of the notification target under the control of the road projection controller 5. In the example in FIG. 12, the road projector 9 projects a notification message 28 saying “PARKING HERE”, in front, on the right of the non-subject vehicle 27.

<Modification>

<Configuration>

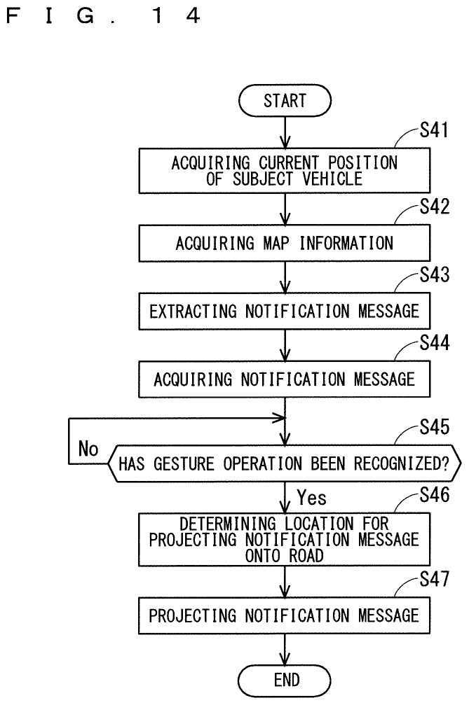

FIG. 13 is a block diagram illustrating one example of the configuration of a notification control apparatus 29 according to a modification of the fourth embodiment.

As illustrated in FIG. 13, the notification control apparatus 29 includes a subject-vehicle position acquiring unit 30, a map information acquiring unit 31, a notification message extracting unit 32, and a notification message storage 33. The other components, which are similar to those of the notification control apparatus 6 in FIG. 2, will not be elaborated upon.

The subject-vehicle position acquiring unit 30 acquires the current position of the subject vehicle from a global positioning system (GPS) and other means. The map information acquiring unit 31 acquires map information including at least a particular place, such as a parking lot.

The notification message extracting unit 32 extracts a notification message from the notification message storage 33 on the basis of the current position of the subject vehicle acquired by the subject-vehicle position acquiring unit 30 and the map information acquired by the map information acquiring unit 31. The notification message storage 33 consists of a storage device (e.g., a hard disk drive or HDD for short, or a semiconductor memory), and stores at least one notification message corresponding to a particular place, such as a parking lot. To be specific, the notification message storage 33 links a notification message that is frequently used in a particular place, with the particular place, and then stores the notification message.

A processing circuit implements the functions of the subject-vehicle position acquiring unit 30, the map information acquiring unit 31, and the notification message extracting unit 32 of the notification control apparatus 29. That is, the notification control apparatus 29 includes a processing circuit for acquiring the current position of the subject vehicle, acquiring map information, and extracting a notification message. The processing circuit is the processor 10 that executes a program stored in the memory 11 as illustrated in FIG. 3. The other functions of the notification control apparatus 29 are similar to those of the notification control apparatus 6 illustrated in FIG. 2.

Software, firmware, or a combination of software and firmware implements the functions of the subject-vehicle position acquiring unit 30, the map information acquiring unit 31, and the notification message extracting unit 32 of the notification control apparatus 29. As illustrated in FIG. 3, the software or firmware is written as a program and stored in the memory 11. The processing circuit reads and executes the program, stored in the memory 11, to implement the functions of the subject-vehicle position acquiring unit 30, the map information acquiring unit 31, and the notification message extracting unit 32. That is, the notification control apparatus 29 includes the memory 11 for storing a program that executes the following process steps: acquiring the current position of the subject vehicle, acquiring map information, and extracting a notification message. This program is for controlling a computer to execute the procedure or method of the subject-vehicle position acquiring unit 30, the map information acquiring unit 31, and the notification message extracting unit 32. The other functions of the notification control apparatus 29 are similar to those of the notification control apparatus 6 illustrated in FIG. 2.

<Operation>

FIG. 14 is a flowchart showing one example of a process performed in the notification control apparatus 29. Steps S45 to S47 in FIG. 14, which respectively correspond to steps S12 to S14 in FIG. 4, will not be elaborated upon. Steps S41 to S44 will be described.

In step S41, the subject-vehicle position acquiring unit 30 acquires the current position of the subject vehicle. In step S42, the map information acquiring unit 31 acquires map information including at least a particular place, such as a parking lot.

In step S43, the notification message extracting unit 32 extracts a notification messages from the notification message storage 33 on the basis of the current position of the subject vehicle acquired by the subject-vehicle position acquiring unit 30 and the map information acquired by the map information acquiring unit 31. As illustrated in FIG. 12 for instance, in which the subject vehicle 26 is in a parking lot, the notification message extracting unit 32 extracts a notification message corresponding to the parking lot from the notification message storage 33.

In step S44, the notification message acquiring unit 2 acquires the notification message extracted by the notification message extracting unit 32.

As described above, the notification control apparatus according to the fourth embodiment enables projection of the notification message onto a suitable location when the subject vehicle is in a particular place, such as a parking lot. That is, the notification control apparatus enables projection of a driver's intention for a notification target selected by the driver onto an intended location. The notification control apparatus thus improves the accuracy of display to the notification target. The configuration of the notification control apparatus 29 particularly enables automatic determination of a notification message. For instance, when the subject vehicle is parked in an empty space in a parking lot, the notification control apparatus allows the subject vehicle to notify a non-subject vehicle that the subject vehicle is being parked in the empty space.

### Fifth Embodiment

<Configuration>

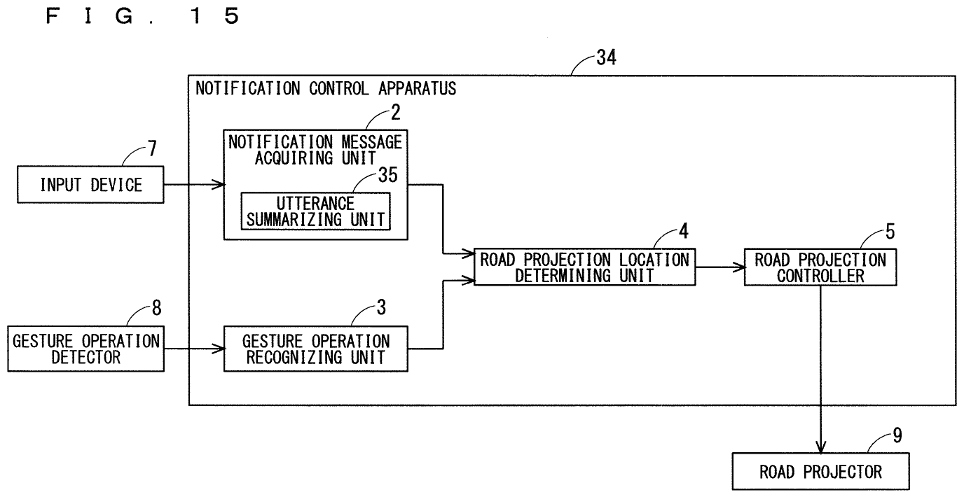

FIG. 15 is a block diagram illustrating one example of the configuration of a notification control apparatus 34 according to a fifth embodiment of the present invention.

As illustrated in FIG. 15, the notification control apparatus 34 includes an utterance summarizing unit 35. The other components, which are similar to those of the notification control apparatus 6 in FIG. 2, will not be elaborated upon.

The utterance summarizing unit 35 summarizes a driver's utterance via the input device 7 to form a notification message. Summarizing the utterance herein means eliminating unnecessary phrases, but leaving the meaning of the driver's utterance as it is.

A processing circuit implements the function of the utterance summarizing unit 35 of the notification control apparatus 34. That is, the notification control apparatus 34 includes a processing circuit for summarizing a driver's utterance to form a notification message. The processing circuit is the processor 10 that executes a program stored in the memory 11 as illustrated in FIG. 3. The other functions of the notification control apparatus 34 are similar to those of the notification control apparatus 6 illustrated in FIG. 2.

Software, firmware, or a combination of software and firmware implements the function of the utterance summarizing unit 35 of the notification control apparatus 34. As illustrated in FIG. 3, the software or firmware is written as a program and stored in the memory 11. The processing circuit reads and executes the program, stored in the memory 11, to implement the function of the utterance summarizing unit 35. That is, the notification control apparatus 34 includes the memory 11 for storing a program that executes a process step of summarizing a driver's utterance to form a notification message. This program is for controlling a computer to execute the procedure or method of the utterance summarizing unit 35. The other functions of the notification control apparatus 34 are similar to those of the notification control apparatus 6 illustrated in FIG. 2.

<Operation>

A process performed in the notification control apparatus 34 is basically the same as that shown in FIG. 4. A characteristic process step in the fifth embodiment will be focused on with reference to FIG. 4.

In step S11, in response to a driver's utterance via the input device 7, the utterance summarizing unit 35 summarizes the driver's utterance to form a notification message. The subsequent process steps are similar to those described in the first embodiment.

As described above, the notification control apparatus according to the fifth embodiment summarizes the driver's utterance to form the notification message. The notification control apparatus thus allows the driver to convey his/her intention with more certainty. That is, the notification control apparatus improves the accuracy of display to the notification target.

### Sixth Embodiment

<Configuration>

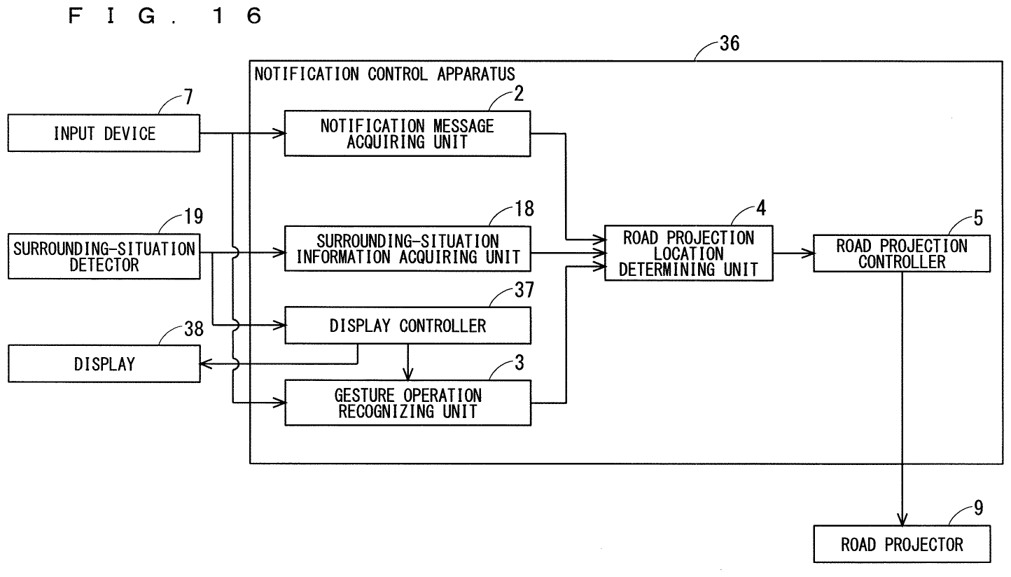

FIG. 16 is a block diagram illustrating one example of the configuration of a notification control apparatus 36 according to a sixth embodiment of the present invention.

As illustrated in FIG. 16, the notification control apparatus 36 includes a display controller 37. The display controller 37 is connected to the surrounding-situation detector 19 and a display 38. The other components, which are similar to those of the notification control apparatus 6 in FIG. 2, will not be elaborated upon.

The display controller 37 controls display of a notification target located around the subject vehicle. To be specific, the display controller 37 controls display of a video image taken by a camera (i.e., surrounding-situation detector 19) capable of taking the surroundings of the subject vehicle, onto the display 38. The driver can make a gesture on the screen of the display 38. For a touch panel included in the display 38, the driver can make a gesture while touching the screen of the display 38. In this case, the display 38 and the input device 7 (i.e., herein, a touch panel) may be a single piece.

A processing circuit implements the function of the display controller 37 of the notification control apparatus 36. That is, the notification control apparatus 36 includes a processing circuit for controlling display of a notification target located around the subject vehicle. The processing circuit is the processor 10 that executes a program stored in the memory 11 as illustrated in FIG. 3. The other functions of the notification control apparatus 36 are similar to those of the notification control apparatus 6 illustrated in FIG. 2.

Software, firmware, or a combination of software and firmware implements the function of the display controller 37 of the notification control apparatus 36. As illustrated in FIG. 3, the software or firmware is written as a program and stored in the memory 11. The processing circuit reads and executes the program, stored in the memory 11, to implement the function of the display controller 37. That is, the notification control apparatus 36 includes the memory 11 for storing a program that executes a process step of controlling display of a notification target located around the subject vehicle. This program is for controlling a computer to execute the procedure or method of the display controller 37. The other functions of the notification control apparatus 36 are similar to those of the notification control apparatus 6 illustrated in FIG. 2.

<Operation>

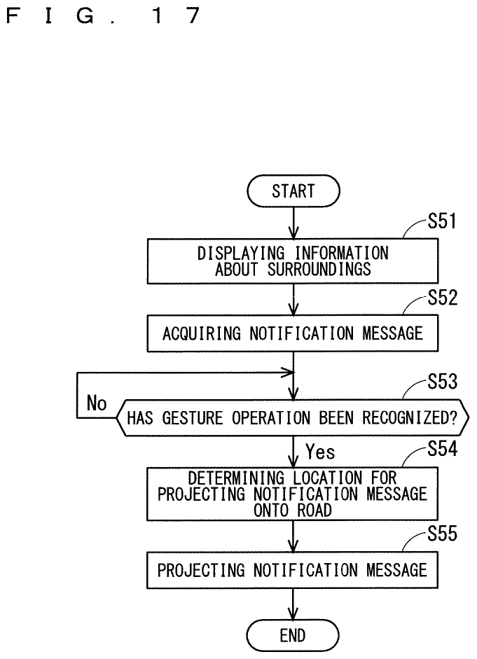

FIG. 17 is a flowchart showing one example of a process performed in the notification control apparatus 36. Step S52 in FIG. 17, which corresponds to step S11 in FIG. 4, will not be elaborated upon. Step S51 and steps S53 to S55 will be described.

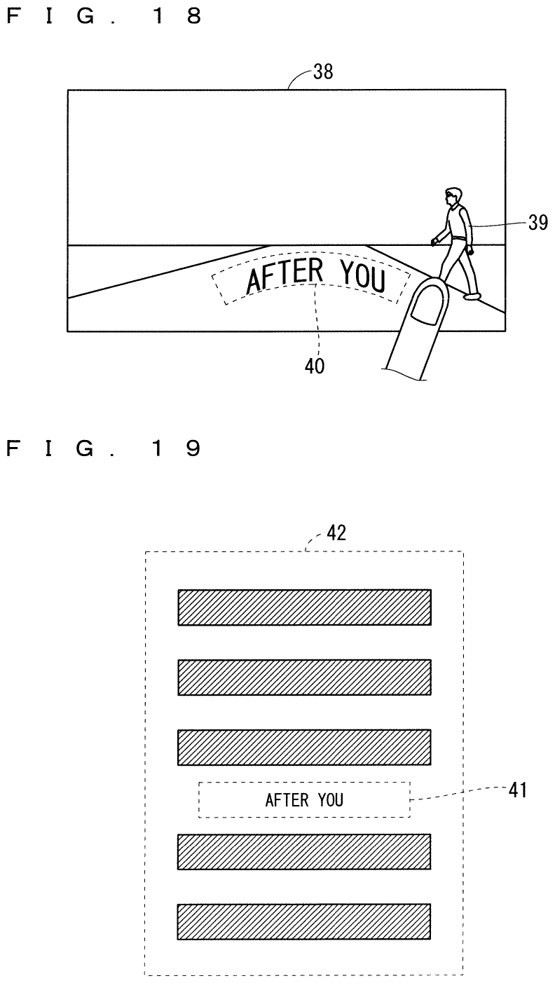

In step S51, the display controller 37 controls display of a video image including a notification target located around the subject vehicle, onto the display 38. The video image is taken by a camera, which is the surrounding-situation detector 19. As illustrated in FIG. 18 for instance, the display 38 displays a video image including a notification target 39.

In step S53, the gesture operation recognizing unit 3 determines whether it has recognized a driver's gesture detected by the gesture operation detector 8. The process repeats step S53 until the recognition of a gesture. Upon the recognition of a gesture, the process proceeds to step S54.

In step S54, the road projection location determining unit 4 determines, on the basis of the gesture recognized by the gesture operation recognizing unit 3, a location for projecting the notification message acquired by the notification message acquiring unit 2 onto a road. In the example in FIG. 18, the driver selects a location for projecting the notification message by stroking the screen of the display 38, that is, by finger gesture on the screen of the display 38. When the gesture operation recognizing unit 3 recognizes the start and end points of the driver's gesture, the road projection location determining unit 4 determines the section between the start and end points of the gesture recognized by the gesture operation recognizing unit 3, as a location for projecting the notification message acquired by the notification message acquiring unit 2 onto a road.

In step S55, the road projection controller 5 controls the road projector 9 to project the notification message onto the location determined by the road projection location determining unit 4. The road projector 9 projects the notification message in front of the notification target under the control of the road projection controller 5. In the example in FIG. 18, the road projector 9 projects a notification message 40 saying “AFTER YOU”, in front of the notification target 39.

It is noted that in step S55, the road projection controller 5 may perform the control so that the notification message follows the movement of the driver's gesture, thus coming into sight. At this time, the driver may input the notification message by voice while stroking the screen of the display 38.

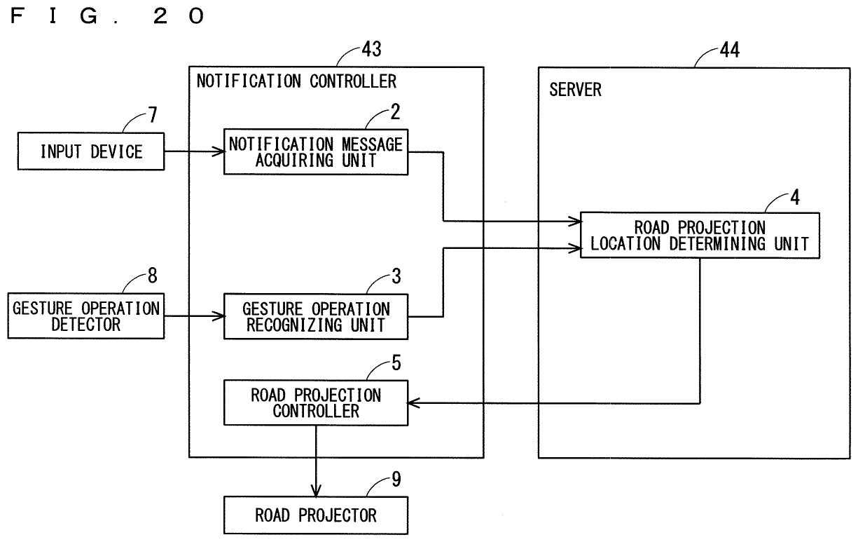

In step S55, the road projection controller 5 may control projection of a notification message 41 and an additional message 42 that is added to the notification message 41, as illustrated in FIG. 19 for instance. In the example in FIG. 19, the notification message 41 says “AFTER YOU”, and the additional message 42 is depicted in the form of a crosswalk. Such projection of an additional message is applicable to the first to fifth embodiments.

As such, for a driver's gesture on the screen of the display 38, the notification control apparatus according to the sixth embodiment achieves an effect similar to that in the first embodiment.

The aforementioned notification control apparatuses each can be included not only in a vehicle-mounted navigation device (i.e., a car navigation device), but also in a navigation device formed as a system in appropriate combination with a vehicle-mountable portable navigation device (PND), an external server, and other things. Alternatively, the display control apparatuses each can be included in a device other than such a navigation device. In this case, the functions or components of each notification control apparatus are distributed, for placement, to respective functions that constitute the above system.

To be specific, the functions of the notification control apparatus can be placed on a server, for instance. As illustrated in FIG. 20 for instance, a user interface includes the notification controller 43, the input device 7, the gesture operation detector 8, and the road projector 9. The notification controller 43 includes the notification message acquiring unit 2, the gesture operation recognizing unit 3, and the road projection controller 5. In addition, a server 44 includes the road projection location determining unit 4. Such a configuration enables a notification system to be established. The same holds true for the notification control apparatus 17 in FIG. 7, the notification control apparatus 29 in FIG. 13, the notification control apparatus 34 in FIG. 15, and the notification control apparatus 36 in FIG. 16.

The above configuration, in which the functions of the notification control apparatus are distributed, for placement, to the respective functions constituting the system, still achieves effects similar to those described in the foregoing embodiments.

Software that executes the process described in each of the foregoing embodiment may be incorporated to a server for instance. The server executes this software to implement notification control. A method for controlling such notification includes the following process steps: acquiring a notification message for a notification target located around the subject vehicle; recognizing a gesture of the driver of the subject vehicle; determining, on the basis of the recognized gesture, a location for projecting the acquired notification message onto a road; and controlling projection of the notification message onto the determined location.

In this way, incorporating software that executes the operation described in the foregoing embodiments, to a server for operation achieves effects similar to those described in the aforementioned embodiments.

It is noted that in the present invention, the individual embodiments can be freely combined, or can be modified and omitted as appropriate, within the scope of the invention.

While the invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 notification control apparatus, 2 notification message acquiring unit, 3 gesture operation recognizing unit, 4 road projection location determining unit, 5 road projection controller, 6 notification control apparatus, 7 input device, 8 gesture operation detector, 9 road projector, 10 processor, 11 memory, 12 notification target, 13 notification message, 14 to 16 notification target, 17 notification control apparatus, 18 surrounding-situation information acquiring unit, 19 surrounding-situation detector, 20 subject vehicle, 21 notification target, 22 non-subject vehicle, 23 notification message, 24 request message, 25 headlight beam, 26 subject vehicle, 27 non-subject vehicle, 28 notification message, 29 notification control apparatus, 30 subject-vehicle position acquiring unit, 31 map information acquiring unit, 32 notification message extracting unit, 33 notification message storage, 34 notification control apparatus, 35 utterance summarizing unit, 36 notification control apparatus, 37 display controller, 38 display, 39 notification target, 40, 41 notification message, 42 additional message, 43 notification controller, 44 server

1. A notification control apparatus comprising:
a processor to execute a program; and
a memory to store the program which, when executed by the processor, performs processes of,
acquiring a notification message for a notification target located around a subject vehicle;
recognizing a gesture of a driver of the subject vehicle;
determining, on the basis of the recognized gesture, a location for projecting the acquired notification message onto a road; and
controlling projection of the notification message onto the determined location.

2. The notification control apparatus according to claim 1, wherein the determining process comprises changing a layout of the notification message in accordance with the gesture.

3. The notification control apparatus according to claim 1, wherein the determining process comprises changing a form of display of the notification message, in accordance with the gesture.

4. The notification control apparatus according to claim 1, wherein the process of acquiring the notification message comprises acquiring a sound indicating the notification message.

5. The notification control apparatus according to claim 1, wherein
the recognizing process comprises recognizing the gesture for selecting one of a plurality of the notification targets located around the subject vehicle, and
the determining process comprises determining a position at which the selected notification target is located, as the location for projecting the notification message.

6. The notification control apparatus according to claim 1, wherein the program, when executed by the processor, further performs a process of acquiring information about surroundings including a relative position of the notification target relative to the subject vehicle.

7. The notification control apparatus according to claim 6, wherein the determining process comprises determining the location for projecting the notification message, on the basis of the gesture and the relative position of the notification target.

8. The notification control apparatus according to claim 6, wherein the process of acquiring the information about surroundings comprises acquiring an orientation of a face of the notification target.

9. The notification control apparatus according to claim 6, wherein
the process of acquiring the information about surroundings comprises acquiring the information about surroundings including the relative position of a plurality of the notification targets, and
for one of the plurality of the notification targets, the determining process comprises determining, on the basis of the gesture, the location for projecting the notification message, and
for the other notification targets, the determining process comprises determining the relative position of the other notification targets as a location for projecting a predetermined message.

10. The notification control apparatus according to claim 1, wherein
the program, when executed by the processor, further performs processes of,
acquiring a current position of the subject vehicle, and
acquiring map information, and
the process of acquiring the notification message comprises acquiring, on the basis of the map information, the notification message corresponding to the current position of the subject vehicle.

11. The notification control apparatus according to claim 4, wherein
the process of acquiring the notification message comprises a process of summarizing an utterance of the driver, and
the summarizing process comprises summarizing the utterance to form the notification message.

12. The notification control apparatus according to claim 4, wherein
the process of acquiring the notification message comprises acquiring a directivity of the sound, and
the determining process comprises determining the location for projecting the notification message onto the road, on the basis of the gesture and the directivity of the sound.

13. The notification control apparatus according to claim 1, wherein
the program, when executed by the processor, further performs a process of controlling display of the notification target located around the subject vehicle, and
the recognizing process comprises recognizing the gesture that is made on a screen on which the notification target is displayed.

14. The notification control apparatus according to claim 13, wherein
the process of acquiring the notification message comprises acquiring a sound indicating the notification message, and
the process of controlling projection comprises performing control so that the notification message follows a movement of the gesture, thus coming into sight.

15. The notification control apparatus according to claim 1, wherein the process of controlling projection comprises controlling projection of the notification message and an additional message that is added to the notification message.

16. A method for controlling notification, comprising:
acquiring a notification message for a notification target located around a subject vehicle;
recognizing a gesture of a driver of the subject vehicle;
determining, on the basis of the recognized gesture, a location for projecting the acquired notification message onto a road; and
controlling projection of the notification message onto the determined location.
